(19) United States
(12) Patent Application Publication
(10) Pub. No.: US 2026/0320101 A1
(43) Pub. Date: Oct. 15, 2026

(54) FLEXIBLE DATA ENTRY

(71) Applicant: Benchling, Inc., San Francisco, CA (US)

(72) Inventors: Alan Garrett Pierce, San Francisco, CA (US); Ashu Singhal, San Francisco, CA (US)

(21) Appl. No.: 19/643,655

(22) Filed: Apr. 9, 2026

Related U.S. Application Data
(60) Provisional application No. 63/786,012, filed on Apr. 9, 2025.

(51) Int. Cl. G06F 16/35; G06F 40/205

(52) U.S. Cl. CPC G06F 16/35; G06F 40/205

(57) ABSTRACT

Methods, systems, and apparatus, including computer programs encoded on a computer storage medium, for flexible data entry. One of the methods includes receiving, by a bioinformatics platform system, source data representing a plurality of attributes of one or more lab entities. A dynamic chunking input is provided to a machine learning model that causes the machine learning model to automatically analyze the source data and to partition the source data into a plurality of chunks to be processed separately. A parsing input is provided to the machine learning model that causes the machine learning model to separately analyze each chunk and to automatically generate, for each chunk, a structured data output corresponding to the attributes in the source data. The automatically generated structured data outputs generated for the plurality of chunks are assembled into a final structured data output.

### CROSS-REFERENCE TO RELATED APPLICATION

This application claims the benefit of priority under 35 U.S.C. § 119(e) of U.S. Provisional Application No. 63/786,012, filed on Apr. 9, 2025, entitled “Flexible Data Entry”, which is herein incorporated by reference in its entirety.

### BACKGROUND

This specification relates to bioinformatics computing platforms for life sciences research and development.

Bioinformatics computing platforms are designed to support laboratory research activities. For example, a bioinformatics computing platform can host an electronic laboratory notebook (ELN) database that can support life sciences research by storing structured data representing laboratory entities, such as organisms, molecular sequences, chemical structures, and material samples, to name just a few examples.

One of the major bottlenecks of using the advanced capabilities of bioinformatics computing platforms is in entering and importing data. For example, many life sciences laboratories have traditionally stored structured data in text files, spreadsheet files, or PDF files. This is a particular problem when a laboratory has built up years or decades of data in such files. Entering such data manually is tedious and error-prone, and manual entry does not scale at all when the size of the data to be imported is large.

### SUMMARY

This specification describes how a computer system can provide a flexible data entry agent, which is a feature that allows users to import hundreds or thousands of structured data rows at a time from a wide variety of document formats, which do not need to be known to the system in advance. By leveraging large language models (LLMs), the flexible data entry agent is able to automatically accommodate many document formats.

Particular embodiments of the subject matter described in this specification can be implemented so as to realize one or more of the following advantages. The flexible data entry system described in this specification provides marked technological improvements over conventional data importing systems. While conventional parsers require rigidly formatted, flat tabular data and fail when confronted with complex layouts, the described system can successfully process poorly formatted, nested, or disjointed legacy data files. This capability allows the computer system to automatically transform unstructured or semi-structured inputs into a highly structured, machine-readable format suitable for advanced bioprocess analysis without requiring tedious manual data wrangling.

The system improves computational efficiency and accuracy by employing a dynamic chunking operation. Instead of using rigid programmatic splits, such as splitting strictly by document page or spreadsheet tab, the system can use a machine learning model to automatically determine optimal, natural data boundaries. The system can then distribute these chunks across multiple parallel computing nodes, which allows the system to process massive datasets efficiently at scale while avoiding awkward data splits that degrade extraction accuracy.

The system further improves the process of data extraction through the use of focus ranges and inline coordinates. By generating specific coordinate boundaries, such as a top-left cell and a bottom-right cell, the system dynamically restricts the primary attention of the parallel workers to the most relevant data blocks. Furthermore, appending inline coordinates to cells allows the system to successfully process excessively wide spreadsheets, such as those with over 100 columns, that typically cause significant accuracy issues for standard extraction methods. These features significantly improve model accuracy with only a minimal impact on operation latency.

Additionally, the system can enhance the operational performance of the underlying machine learning models themselves by explicitly generating intermediate scratch columns. By forcing the models to output their multi-step reasoning, such as mapping external legacy IDs to modern internal system IDs via intermediate coordinates, the system can significantly improve output accuracy. This unique structure allows the system to execute complex thought chains in the middle of a large data extraction process, rather than requiring such thoughts to appear exclusively at the beginning of an output.

In addition, the system can improve overall data integrity and reliability by utilizing an automated cross-model verification process. By executing the extraction task in parallel across multiple independent machine learning models with different architectures, the system algorithmically cross-checks the structured data outputs against each other. This automatic verification drastically reduces subtle transcription errors that might occur when running a single model. When discrepancies do occur, the system can pinpoint and highlight specific cell-level differences in a visual interface, providing a highly efficient feedback loop for error resolution.

The flexible data entry system described in this specification can also significantly improve collaboration across different companies and organizations. For example, a primary organization often works with a separate entity, such as a contract research organization, to perform experiments. In these scenarios, the experimental results provided by the separate entity often do not match the specific data formats used by the primary organization. By utilizing the flexible data entry techniques described below, the primary organization can easily and automatically ingest and restructure the external data without requiring tedious manual reformatting. This capability streamlines cross-organizational workflows and reduces the friction associated with sharing scientific data between disparate systems.

Furthermore, the flexible data entry techniques described in this specification provide significant technological advantages even when the source data is already well-structured but needs to be translated into a different structure. For example, a data entry task might require importing information that uses different terminology or a different identification system than the destination database. Additionally, the source data might need to be joined into a single comprehensive table or split into separate tables depending on the specific organizational needs of the system being imported into. The flexible data entry system can automatically perform these complex restructuring tasks. This ensures that the imported data seamlessly integrates with the existing platform formats.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system that can perform flexible data entry to import data from a wide variety of document formats.

FIG. 2 is a flowchart of an example process for generating a structured data output from source data.

FIG. 3A depicts an example input source spreadsheet.

FIG. 3B illustrates an example user interface presentation.

FIG. 3C illustrates an example electronic laboratory notebook entry.

Like reference numbers and designations in the various drawings indicate like elements.

### DETAILED DESCRIPTION

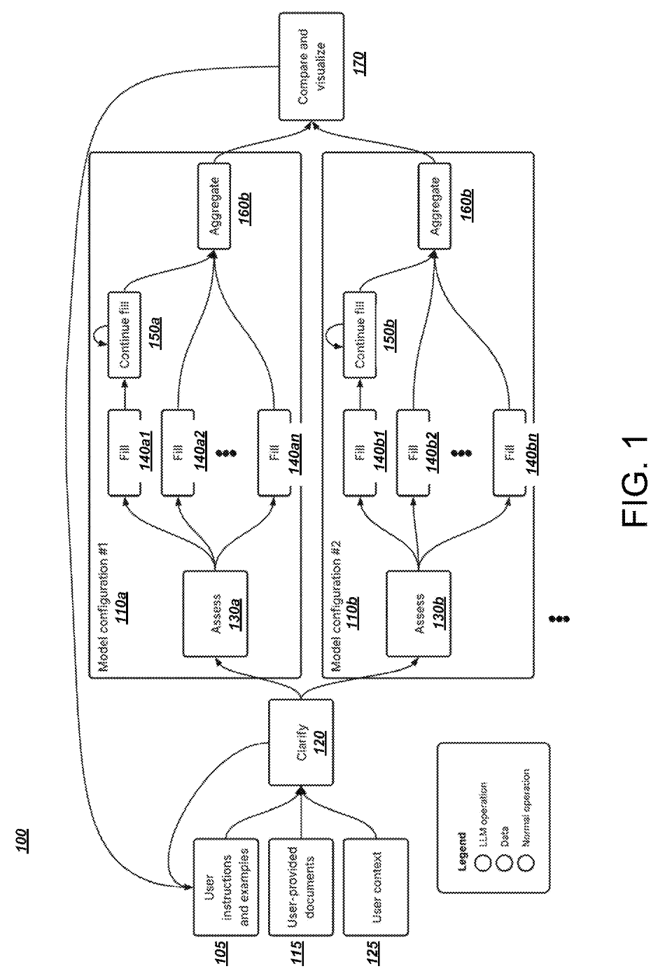

FIG. 1 is a diagram of an example system 100 that can perform flexible data entry to import data from a wide variety of document formats. The system can utilize large language models in a multi-phase workflow that dynamically splits work to allow parallel data entry at a large scale. Furthermore, the system can run these operations in parallel using different model configurations to cross-check the results for accuracy. The system is an example of a system implemented as computer programs on one or more computers in one or more locations in which the systems, components, and techniques described below are implemented.

In a typical implementation, the system can execute all of the large language model tasks by spinning them out onto their own respective nodes in a distributed, multi-node computing system having one or more deployed large language models. By assigning these large language model operations to separate processing devices, the system can dynamically split the work to allow parallel data entry at a large scale. This distributed approach abstracts the complexities of parallel computing away from the end user. However, a distributed architecture need not be the case in all implementations. Alternatively, the system can be configured such that all large language model operations are performed by the same deployed large language model.

The workflow illustrated in FIG. 1 uses several large language model (LLM) operations to effectuate the flexible data entry functionalities described in this specification. The system can use a variety of different large language models to perform these data entry operations. Unless otherwise specified, for example, in the case of the explicitly noted different model configurations, the system can use the same large language model or specially configured large language models, or some combination of these, for each of the LLM operations described.

The workflow can use a number of user data sources, for example, user instructions and examples 105, user-provided documents 115, and user context 125.

The system can receive user instructions and examples 105 to guide the flexible data entry task. For example, the user can provide any appropriate instructions that might be helpful in clarifying the task, such as specifying the structure of the input documents or the intended output format of each row or column. These instructions and examples help the system understand specific requirements for extracting the data, and if the task is ambiguous, the user may refine these instructions based on AI-generated guidance.

The user-provided documents 115 contain the source data to be imported. For example, the user can select one or more documents to import, and these documents can be stored in a variety of appropriate electronic file formats, such as text files, Excel spreadsheets, Word documents, or digital and scanned PDF files. Often, this source data is originally structured for human readability rather than machine interpretability, such as tables listing tedious results of lab experiments, e.g., tables of lipid plasma concentration data. The system can use the workflow described in this specification to process these various formats to extract information without the specific document formats needing to be known to the system in advance.

The system can additionally utilize user context 125 to assist in accurately interpreting the source data. For example, the system can receive an entire electronic laboratory notebook entry to include as context for the data extraction task. Including this notebook entry context can be particularly helpful to provide mappings between an identification system used in the user-provided documents and an identification system used internally within the bioinformatics platform.

The system can perform a clarify operation 120 that first determines whether there are any ambiguities in the data entry task. To perform this operation, the system can send the user instructions 105, user-provided documents 115, and user context 125 to a large language model to assess the entire task for ambiguities. If the large language model determines that the task contains ambiguities, the system can provide AI-generated guidance to assist the user in resolving the ambiguities. This allows the user to refine their instructions before the system proceeds with the main data extraction process.

As one example of an ambiguity, a user might upload a spreadsheet containing lipid plasma concentrations for several groups of test animals. The spreadsheet tracks each animal's concentration across multiple timepoints (e.g., 0.00, 3.00, and 168 hours) and might record some unmeasurable values as "BQL" (Below Quantifiable Limit). If the user provides a very basic instruction such as, "Extract the concentration data for each animal," the clarify operation 120 can uncover a few ambiguities.

First, the system would not know how to handle the time series data. Because each animal may have concentration readings for three different timepoints, the system might not know whether it should create a separate table row for every timepoint, calculate an average concentration across all three timepoints, or only extract the concentration from the final timepoint. Second, the system might not know how to handle the non-numeric "BQL" values. The basic user instruction did not specify whether "BQL" should be imported exactly as the text string "BQL", converted to a numerical zero, or if those specific readings should just be skipped entirely.

In this scenario, the system's clarify operation 120 can send the task to a large language model, which would detect these ambiguities and provide AI-generated guidance back to the user to specify in the user instructions 105 how to handle such ambiguities. The feedback loop would prompt the user to refine their instructions to resolve the missing details before the parallel data extraction begins. To resolve the ambiguity, the user might update their instruction to be more precise, for example, by specifying "Fill one row per group/animal value, including BQL values. Timepoints should be 0.00, 3.00, or 168".

The system can utilize different model configurations 110a and 110b to perform cross-model verification. By running the same data entry task through multiple artificial intelligence models in parallel, the system can check the results against each other for correctness. This approach can significantly reduce the chances of subtle data transcription errors that might occur when relying on a single model. To increase the likelihood that the model results are truly independent, the system can employ different configurations of the same model or entirely different model families for the separate configurations 110a and 110b, such as Anthropic Claude and OpenAI GPT.

The system can execute assess operations 130a and 130b to analyze the data entry task and establish a processing strategy before parallel extraction begins. This strategy determination includes deciding how to dynamically split the input dataset into smaller, manageable chunks. Because input documents vary significantly in nature, simply splitting by PDF page or Excel sheet can be ineffective and might inadvertently divide related data points across different chunks. Instead, the assess operations 130a and 130b can utilize dynamic chunking by prompting a large language model to determine the optimal grouping strategy for the specific document. For example, the system can ask the model to produce a list of short string descriptions for chunks based on natural groupings, such as "Groups A through C" or "Groups D through F", to divide the work into a target number of chunks, e.g., between eight and twenty chunks. By generating these natural units of work, the system can ensure that individual output rows are never split across multiple parallel workers, which increases overall accuracy.

In addition to establishing chunk boundaries, the assess operations 130a and 130b can establish specific extraction parameters for each chunk, such as focus ranges and scratch columns. A focus range is a mechanism to promote a specific section of the input document as the primary data source for a corresponding chunk, which helps the large language model direct its attention accurately. For instance, the assess operations can output focus range selectors formatted in JSON that specify a range of line numbers in a text file or specific cell coordinates within a particular sheet of an Excel workbook. Furthermore, the assess operations 130a and 130b can define scratch columns to facilitate multi-step reasoning for complex lookups. Instead of attempting to compute a final mapped value in a single step, the system can define a scratch column that extracts the raw text from the document, allowing a subsequent step to translate that raw text into an internal database identifier. Ultimately, the decisions made during the assess operations 130a and 130b are passed to the parallel workers to ensure a consistent extraction approach across all chunks.

As a specific example of how the system can implement the assess operations, the system can pass a detailed system prompt to a large language model to govern the assessment phase. One example is given in Appendix I of U.S. Provisional Patent Application No. 63/786,012, which is herein incorporated by reference. In that example, the system can instruct the model to formulate its assessment using three distinct sections separated by specific tags. The system can then instruct the model to first output its initial thoughts on how to best divide the input into chunks, then output its thoughts on the nuances of filling out specific columns, and finally output a structured response containing the detailed chunk plans and a sample first row. Furthermore, the system can use the system prompt to enforce strict data formatting rules during the parallel fill operations. For instance, the system can instruct the model to represent all extracted cell values as strings and to write decimal numbers exactly as they appear in the source text, including any trailing zeros, so that scientific precision is properly maintained. The system can also instruct the model to automatically convert non-standard hyphens from word processing programs into standard hyphens, and to output an empty string whenever a data point is blank or not applicable.

After the assess operations establish the chunking strategy, the system can execute parallel fill operations to extract structured data from the multiple document chunks simultaneously. For example, within the first model configuration, the system can utilize parallel fill operations 140a1, 140a2, through 140an to process various chunks of the input dataset concurrently. Similarly, within the second model configuration, the system can execute parallel fill operations 140b1, 140b2, through 140bn to process those same chunks independently and simultaneously. By dynamically splitting the input dataset into these smaller chunks and assigning each to a parallel worker, the system can keep the operation within a reasonable running time and reduce the overall latency of the data entry task. During these fill operations, the system can employ a transcription-based approach in which the respective large language model views the full input set alongside a specific string description of the chunk to produce the output data directly. This parallelized architecture helps to ensure that the system can scale efficiently even when importing hundreds of rows of data from large or complex source documents.

A specific example of a fill operation is a fill_structured_table_chunk function. This function is designed to process a single chunk of data by sending a specific string description of the sub-task to the large language model. To execute this operation, the system utilizes a FILL_STRUCTURED_TABLE_CHUNK_SYSTEM_PROMPT that instructs the model to format its response into two distinct sections separated by XML-like tags.

First, the system instructs the model to generate a `<thoughts>` section containing a few sentences that describe the task and reason through the position information, such as Excel coordinates, for the first row it intends to fill. Second, the model must generate a `<response>` section containing a JSON object that conforms to a strict schema. This schema requires the model to output an array of the filled rows and an is_end_of_chunk boolean flag. Because a chunk might contain more rows than can fit within a single language model output limit, the function implements pagination. The function checks the is_end_of_chunk flag, and if there are more rows to process, it enters a `while` loop that continues to prompt the model up to a maximum number of iterations. During these continuation calls, the system provides the model with the rows it has already produced and instructs it to continue from there.

The system can also execute continue fill operations 150a and 150b to repeatedly produce rows for a given chunk until the data extraction for that chunk is complete. Because a single chunk of data might contain more rows than can fit within a single large language model output limit, the system can implement pagination through these continue fill operations. To facilitate this process, the system can instruct the model to output a boolean flag, such as an is_end_of_chunk flag, alongside the array of extracted rows. If there are more rows to process for the assigned chunk, the model sets this flag to false. In response to a false flag, the system triggers the continue fill operation 150a or 150b, which enters a loop that prompts the model again. During these continuation calls, the system can provide the model with the specific rows it has already produced and instruct the model to continue extraction from exactly where it left off. This loop can repeat up to a maximum number of iterations, ensuring that all data within a large chunk is fully processed without exceeding token limits.

The system can then execute aggregate operations 160a and 160b to combine the extracted data from the parallel fill operations into a complete dataset. Following the parallel fill operations 140 and any necessary continue fill operations 150, each model configuration produces a set of structured data rows corresponding to its assigned chunks. Because the assess operations 130a-b previously ensured that individual output rows are not split across multiple chunks, the system can simply concatenate the results from all the parallel workers. For example, the aggregate operation 160a can concatenate the rows produced by the fill operations 140a1 through 140an to form a full set of results for the first model configuration. Similarly, the aggregate operation 160b can combine the extracted rows from the second model configuration 110b. Once the data is fully aggregated within each respective configuration, the system can pass these complete datasets to a compare and visualize operation 170 to check the independent model runs against each other for accuracy.

The system can then perform a compare and visualize operation 170 to evaluate the aggregated results from the independent model runs against each other for accuracy. Using a custom matching algorithm, the system can compare the extracted data rows to determine whether the results can be automatically verified. The system can then present the tentative results to the user in a visual interface. If the models reach full agreement, the user can have high confidence that no transcription errors occurred, and the system can automatically verify the results.

If the model runs yield different results, the compare and visualize operation 170 can initiate a feedback loop to help the user resolve the discrepancies. For example, if there are small disagreements between the model outputs, the system can highlight the specific cell-level differences, allowing the user to manually check and correct the specific issues. If there are significant disagreements, the system can consider the overall result unverified. In response to these highlighted differences or unverified results, the user can utilize the feedback loop to re-run the operation with updated user instructions and examples to clear up any lingering ambiguities. Once the user is satisfied with the output and all ambiguities are resolved, the user can accept the results to be formally included in their electronic laboratory notebook table.

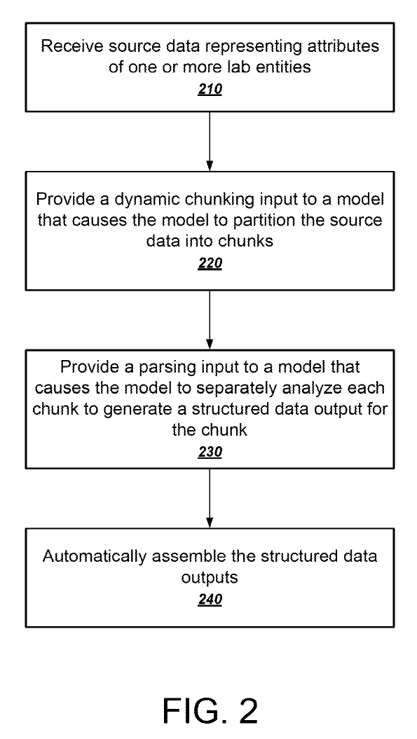

FIG. 2 is a flowchart of an example process for generating a structured data output from source data. The example process can be performed by a bioinformatics platform system implemented as one or more computers in one or more locations and programmed in accordance with this specification. The example process will be described as being performed by a system of one or more computers.

The system receives source data representing a plurality of attributes of one or more lab entities (210). For example, the system can provide a user interface presentation that allows a user to select one or more electronic files that store the original data. The one or more electronic files can be PDF files, spreadsheet files, document files, or text files. Additionally, the system can provide, within the user interface presentation for selecting the one or more electronic files, an element for receiving an auxiliary user input for parsing the original data. Furthermore, receiving the source data can include receiving an identification of a portion or an entire electronic laboratory notebook to be included as context or as part of the source data.

The system provides a dynamic chunking input to a model that causes the model to partition the source data into chunks (220). The machine learning model can be a large language model configured to autoregressively apply self-attention at each of a plurality of generation steps. For example, prior to providing the parsing input, the system can provide a clarification input to the machine learning model that, when processed by the machine learning model, causes the machine learning model to determine whether there are one or more ambiguities in a data entry task. The system can then provide model-generated guidance describing how a user can refine user instructions for the data entry task based on the determined one or more ambiguities. Furthermore, the dynamic chunking input can cause the machine learning model to generate one or more focus ranges that promote a specific section of the source data as a primary data source for a corresponding chunk of the plurality of chunks.

The system provides a parsing input to a model that causes the model to separately analyze each chunk to generate a structured data output for the chunk (230). For example, if the user provided auxiliary user input through the user interface presentation, the system can provide the auxiliary user input received through the user interface presentation as part of the parsing input. During this step, the parsing input can cause the machine learning model to generate one or more intermediate scratch columns to facilitate multi-step reasoning lookups for generating the structured data output. Additionally, providing the parsing input to the machine learning model can include receiving, from the machine learning model, a flag indicating whether an end of a respective chunk has been reached. In response to determining that the flag indicates there are more rows to process for the respective chunk, the system can repeatedly provide already generated rows back to the machine learning model to continue an extraction process until the flag indicates the end of the respective chunk has been reached.

The system automatically assembles the structured data outputs (240). After assembling the outputs, the system can present a visual representation of the final structured data output assembled from the automatically generated structured data outputs. Furthermore, the system can generate an electronic laboratory notebook entry based on the automatically generated structured data output and store the electronic laboratory notebook entry in an electronic notebook entry database. At this stage, the system can also receive a user input that represents user verification of the automatically generated structured data output.

To ensure accuracy, as described above, the system can perform an automatic verification process. As part of this process, the system can provide a second parsing input to a second machine learning model that, when processed by the second machine learning model, causes the second machine learning model to separately analyze each separate chunk and to generate, for each chunk, a second structured data output corresponding to the plurality of attributes of the one or more lab entities in the source data. This second machine learning model can have a different architecture or a different configuration than the first machine learning model. The system can compare the structured data outputs generated by the machine learning model and the second machine learning model according to one or more comparison criteria. If the system determines that the structured data outputs generated by the first machine learning model satisfy the one or more comparison criteria, the system can designate the structured data outputs generated by the first machine learning model as being automatically verified. Alternatively, the system can determine that the structured data outputs generated by the machine learning model and the second machine learning model do not satisfy the one or more comparison criteria. In this scenario, the system can present a visual representation that highlights differences between the structured data outputs generated by the machine learning model and the second machine learning model. The system can then receive a user input through the visual representation to correct the cell-level differences or to provide updated instructions to resolve the cell-level differences.

To evaluate the aggregated results from the parallel model runs, the system can employ a custom matching process that performs a best-effort matching process between the sets of structured data rows. When comparing a first set of output rows against a second set of output rows, the system can first determine whether the results are exactly the same. If the results are the same, the system can produce a list of match results that fully match.

If the results are not an exact match, the system can match the rows as closely as possible based on one or more heuristics. For example, the system can utilize a matching heuristic based on the assumption that earlier columns in a table are generally more representative of a row's identity. Based on this assumption, the system can preferentially match rows that share the same prefix and specifically prefer those matching prefixes to be as long as possible. To implement prefix-based matching, the system can iteratively try every possible prefix length, evaluating from the longest possible prefix down to the shortest. At each evaluated prefix length, the system can match unique rows from the first set and the second set that share that specific prefix. If multiple rows in a phase share the exact same prefix, the system can tie-break and match them according to their index order, meaning their original position within the dataset. Finally, if there are any rows left over after this prefix matching process is complete, the system can generate match results representing those unmatched rows, allowing the user interface to highlight them as specific missing or extra rows.

The cross-model verification process can be further extended to provide advanced error correction and latency optimization. For example, rather than simply identifying discrepancies between two models, the system can automatically correct errors by executing the data extraction task in parallel across three or more machine learning models. In this configuration, the system can automatically select a structured data value that is chosen by at least two of the machine learning models, effectively implementing a majority voting mechanism to resolve isolated transcription errors without requiring manual user intervention.

Alternatively, or in addition, to optimize operational latency and improve wait times for the user, the system can execute the extraction task across a combination of fast and slow machine learning models in parallel. For example, the system can be configured to run two fast models and three slow models simultaneously. The system can then designate the structured data output as automatically verified as soon as any two independent models yield the same result. This racing configuration speeds up the overall data extraction operation for simpler data chunks while preserving the ability to accurately process the hardest cases using the slower, more capable models.

Alternatively, or in addition, the verification framework can be extended to utilize multiple different data extraction strategies rather than relying exclusively on different model architectures. For example, instead of instructing all parallel workers to directly output the structured data tables, the system can instruct at least one of the machine learning models to generate parsing code that programmatically extracts the data. The system can then compare the final table output of the executed parsing code against the direct table output generated by another machine learning model to complete the verification process.

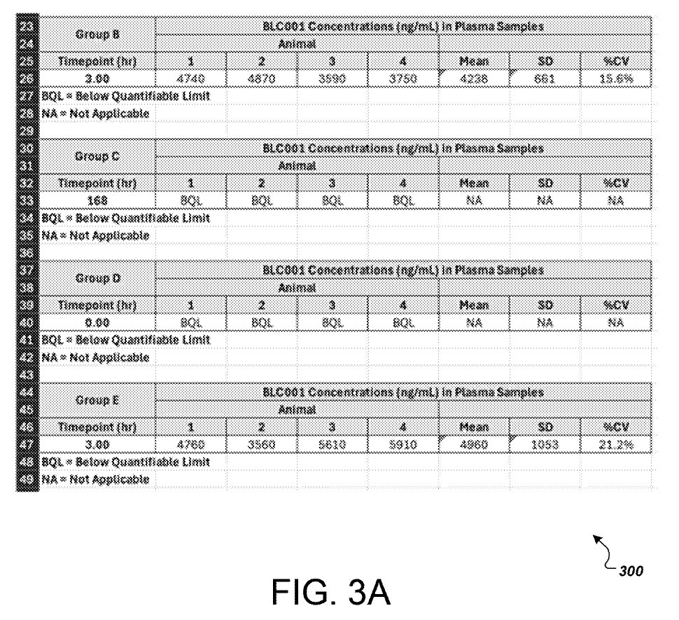

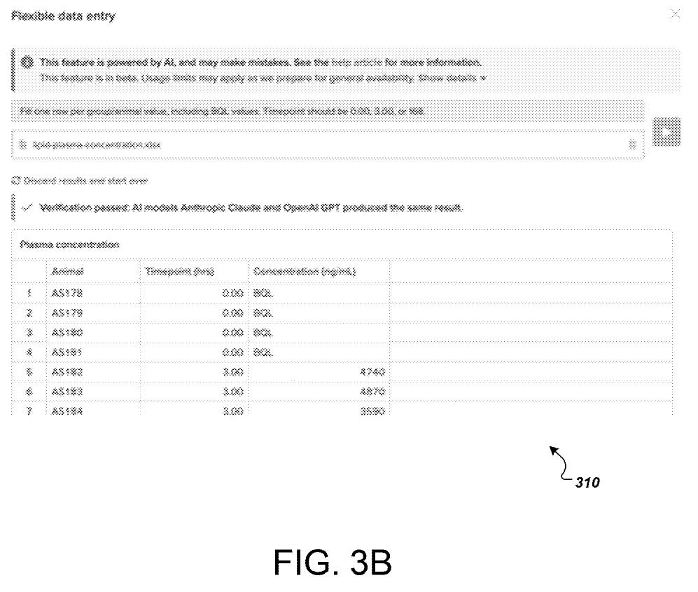

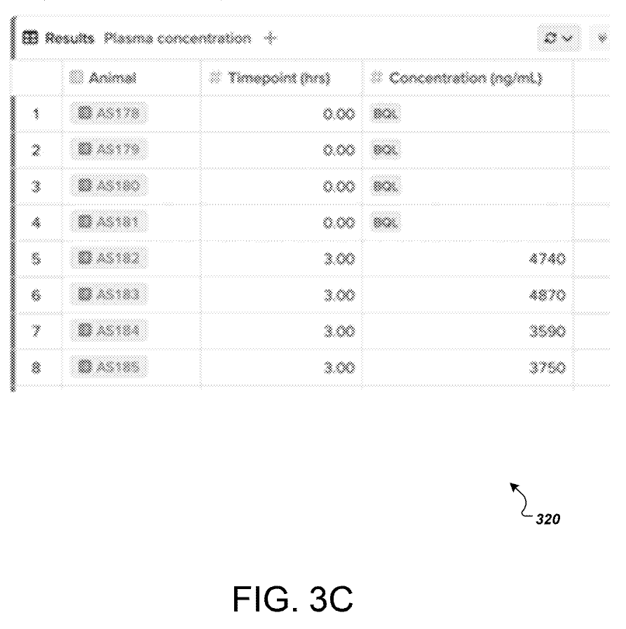

FIG. 3A depicts an example spreadsheet 300 that maintains lipid plasma concentration levels. The spreadsheet 300 is an example of typical lab source data that has been structured entirely for human readability rather than machine interpretability. Specifically, the spreadsheet 300 contains multiple disjointed mini-tables separated by different experimental groups (e.g., Group B, Group C, Group D). It features complex, nested hierarchical headers (e.g., Animal numbers 1, 2, 3, and 4 nested under the main concentration header), varying timepoints, blank rows separating the data blocks, and scattered textual footnotes defining acronyms like "BQL" (Below Quantifiable Limit) and "NA" (Not Applicable).

Attempting to import this data manually would be incredibly tedious and highly prone to human transcription errors, particularly when scaling up to hundreds, thousands, or millions of rows across many files. Using conventional data importing systems would be equally problematic because those systems typically expect rigidly formatted, flat tabular data, such as a standard CSV file. A conventional parser would completely fail to navigate the nested headers, disjointed group blocks, and interspersed textual footnotes.

Furthermore, simple programmatic chunking strategies, such as attempting to split the data by Excel sheet or by enumerating identifying rows, would also fail because the data points are scattered awkwardly across a complex visual layout.

However, the flexible data entry techniques described in this specification can elegantly solve these challenges. Instead of relying on rigid programmatic splits that break the data awkwardly, the system can use large language models to assess the data and create natural, human-understandable work chunks (e.g., assigning "Group B" to one parallel worker and "Group C" to another). In addition, to help the models navigate the sprawling spreadsheet, the chunking step can generate specific Excel coordinate boundaries (e.g., specifying a "top_left_cell" and "bottom_right_cell") to point each parallel worker directly to the relevant visual block of data. Moreover, because spreadsheets like this can be very wide and rely heavily on visual alignment, the system can present the spreadsheet to the model with inline coordinates attached to each cell. The model can then use scratch columns to perform the multi-step reasoning required to flatten the nested headers. For example, the model can use a scratch column to explicitly trace that a value of "4740" belongs to Animal 1, in Group B, at Timepoint 3.00, by referencing the specific intersecting cell coordinates before producing the final clean row of data.

FIG. 3B illustrates an example user interface presentation 310 displaying the verified, structured data output generated by the flexible data entry system. The user interface presentation displays the extracted data in a clean, easily readable tabular format, which stands in stark contrast to the disjointed and complex source spreadsheet shown in FIG. 3A. Furthermore, the interface displays the original file attachment alongside the specific natural language instructions provided by the user to guide the extraction.

A key feature of this user interface presentation is the display of the cross-model verification results. Because the system runs the extraction task in parallel across multiple independent machine learning models, such as Anthropic Claude and OpenAI GPT, the interface can present a prominent verification message when the models reach full agreement. This automatic verification provides the user with high confidence that the extracted data is accurate and free of subtle transcription errors.

Ultimately, this visual interface demonstrates how an otherwise highly manual and error-prone data import task is rendered essentially effortless for the user. The system automatically handles the complex dynamic chunking, multi-step coordinate reasoning, and cross-checking in the background. Once the user is satisfied with the visual representation of the tentative results, the user can provide an input representing their verification of the data. The system can then seamlessly generate an electronic laboratory notebook (ELN) entry based on this structured data output and store it in an electronic notebook entry database. By automatically transforming messy source files into highly structured tables, the system ensures the data is immediately available for downstream bioprocess analysis and integration with other bioinformatics tools.

FIG. 3C illustrates an example electronic laboratory notebook entry 320 populated with the final structured data output. The system can display the extracted lipid plasma concentration data seamlessly integrated into the bioinformatics platform's native table format, complete with generated relational links for the specific animal entities.

This final result represents a massive savings in time and effort, particularly for legacy laboratories. Many life sciences laboratories have built up years or decades of data stored in rigid, poorly formatted text files, PDF files, or disjointed spreadsheets. Manually entering this historical data is an incredibly tedious and error-prone process that does not scale when the size of the data to be imported grows.

By utilizing the flexible data entry system to automatically transform messy legacy data into a clean, structured format, laboratories can easily integrate their historical results into a modern bioinformatics platform. Once the user approves the data and the system imports the data into the electronic laboratory notebook, the system can make this structured data available for advanced bioprocess analysis via other modern bioinformatics tools, such as data warehouses or automated curve fitting and predictive machine learning algorithms, an advantage that would not have been possible without the functionality of the flexible data entry system.

In this specification, electronic lab notebooks (ELNs) are computer-implemented systems that provide digital environments for recording, organizing, and storing experimental data generated in laboratory settings. A basic ELN system can allow users to create entries that incorporate textual descriptions of experimental procedures, observational notes, and associated data files such as images, instrument outputs, or spreadsheets. Furthermore, the system can provide features such as timestamping, version control, and user authentication to maintain data integrity and to support compliance with regulatory or organizational requirements. In many implementations, the system can structure ELNs as collections of discrete experiment records that are stored in document-oriented formats, with limited standardization of data fields across entries. As a result, while the system can serve as a repository for preserving experimental history, the underlying data is often unstructured or semi-structured and may be difficult to aggregate, query, or analyze across multiple experiments or users.

An enhanced electronic lab notebook can be implemented as part of an integrated scientific data platform that is configured to capture, manage, and interrelate both structured and unstructured experimental data across a plurality of experiments, entities, and workflows. Such an enhanced system can provide schema-driven data entry interfaces, such as templates with predefined fields, selectable parameters, and controlled vocabularies, thereby allowing experimental data to be recorded in a structured and machine-readable format. The system can further associate experimental records with underlying scientific entities, such as biological sequences, chemical structures, samples, or reagents, and maintain relationships between such entities across multiple experiments. In some implementations, the system can provide user interface presentations that integrate experimental documentation with domain-specific visualization and editing tools, for example by allowing users to view, modify, and analyze sequence data or molecular structures within the same interface used to document experimental procedures. By unifying experimental records with structured data models and domain-specific computational tools, the system can facilitate improved data traceability, cross-experiment analysis, and automated downstream processing.

The flexible data entry techniques described in this specification can be used to efficiently populate legacy electronic lab notebooks with historical experimental data. For example, the system can automatically extract and verify data from poorly formatted legacy files to generate basic structured outputs for standard database storage. However, the system can provide further advantages when populating an enhanced electronic lab notebook. Because the system can output highly structured, verified data that includes explicitly generated intermediate scratch columns and relational links, the system can seamlessly integrate this data into the schema-driven interfaces of an enhanced notebook. For example, the system can automatically map historical legacy IDs to modern internal system IDs, generate persistent component links between molecular entities, and make the newly structured data immediately available for advanced bioprocess analysis via automated curve fitting and predictive machine learning algorithms. Additionally, the system can present real-time visualizations of the structured data directly within the enhanced notebook, allowing researchers to effortlessly cross-check and utilize their legacy data alongside modern experimental results.

Suitable techniques for using a bioinformatics system to work with electronic laboratory notebook subsystems and other tools are described in commonly owned U.S. Patent Application No. 18/665,429, filed May 15, 2024, and entitled “COMPUTING PLATFORM FOR BIOPROCESS DESIGN, EXECUTION, ANALYSIS, AND TECHNOLOGY TRANSFER,”; and U.S. Patent Application No. 18/807846, filed Aug. 16,2024,4 and entitled “BIOPROCESS EXECUTION WORKFLOW INTERFACES.” The entirely of these applications are herein incorporated by reference.

In this specification, a large language model refers to a neural network-based computer system configured to process sequences of discrete elements, such as tokens, and to generate one or more output representations or output tokens based on the sequences. Large language models can be implemented using a variety of architectures, including architectures that employ one or more transformer layers, attention mechanisms, recurrent components, state-space components, or combinations thereof. In some implementations, a large language model is configured to generate output tokens conditioned on one or more input tokens, for example in an autoregressive manner, while in other implementations the model is configured to generate representations of an input sequence for use in downstream tasks.

Suitable large language models can include encoder architectures, decoder architectures, or encoder-decoder architectures. An encoder refers to a language model architecture that includes one or more processing layers that receive an input sequence of tokens and produce one or more output representations of the sequence. These representations can be used for various downstream tasks, such as classification, retrieval, or further generative processing. A decoder refers to a language model architecture that includes one or more processing layers that generate one or more output tokens conditioned on a sequence of input tokens. In some implementations, encoder-decoder architectures combine both functionalities, for example by generating output tokens based on encoded representations of an input sequence. In practice, input sequences provided to such models are often represented as learned embeddings, i.e., vector representations of the individual elements of the sequence.

The flexible data entry techniques described in this specification can also be deployed as a tool that is accessible to an artificial intelligence-based agentic system as opposed to being operated by a human user. When configured in this manner, an agentic system can autonomously prepare user instructions and run the flexible data entry operations. Furthermore, the agentic system can automatically refine its instructions over time to ensure that the source data is cleanly transformed into the final structured data output.

Furthermore, the agentic system can utilize the cross-model verification results to autonomously evaluate the accuracy of the data extraction task. For example, the agentic system can analyze the verification results across multiple parallel strategies, such as determining that five out of eight parallel strategies produced results that exactly matched, to make a programmatic decision on whether to accept the results. Alternatively, or in addition, if the model runs yield unverified results, the agentic system can review any discrepancies and generate a summary of the differences. The system can then present this summary to a human user in a visual interface in a way that helps the human user understand how to best resolve any remaining ambiguities or errors. Alternatively, or in addition, the system can use the discrepancies as additional context to make another attempt at data extraction.

The flexible data entry system described in this specification can also be easily integrated with user-specific import modules, which are often referred to as data import “skills.” Such skills can be used to perform common import tasks. The flexible data entry techniques described in this specification can fully integrate with such custom data importation skills. The skills can either be specified directly by a user or discovered automatically by the flexible data entry system.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, by a bioinformatics platform system comprising a plurality of computers, source data representing a plurality of attributes of one or more lab entities;
providing a dynamic chunking input to a machine learning model that, when processed by the machine learning model, causes the machine learning model to automatically analyze the source data and to partition the source data into a plurality of chunks to be processed separately;
providing a parsing input to the machine learning model that, when processed by the machine learning model, causes the machine learning model to separately analyze each separate chunk automatically generated by the model and to automatically generate, for each chunk, a structured data output corresponding to the plurality of attributes of the one or more lab entities in the source data; and
assembling the automatically generated structured data outputs generated for the plurality of chunks into a final structured data output.

2. The method of claim 1, further comprising:
presenting a visual representation of the final structured data output assembled from the automatically generated structured data outputs.

3. The method of claim 1, further comprising:
generating an electronic laboratory notebook entry based on the automatically generated structured data output; and
storing the electronic laboratory notebook entry in an electronic notebook entry database.

4. The method of claim 1, further comprising receiving a user input that represents user verification of the automatically generated structured data output.

5. The method of claim 1, further comprising:
performing an automatic verification process comprising:
providing a second parsing input to a second machine learning model that, when processed by the second machine learning model, causes the second machine learning model to separately analyze each separate chunk and to generate, for each chunk, a second structured data output corresponding to the plurality of attributes of the one or more lab entities in the source data;
comparing the structured data outputs generated by the machine learning model and the second machine learning model according to one or more comparison criteria;
determining that the structured data outputs generated by the first machine learning model satisfy the one or more comparison criteria; and
designating the structured data outputs generated by the first machine learning model as being automatically verified.

6. The method of claim 5, wherein the second machine learning model has a different architecture than the machine learning model.

7. The method of claim 6, wherein the second machine learning model has a different configuration than the machine learning model.

8. The method of claim 1, further comprising:
providing a user interface presentation that allows a user to select one or more electronic files that store the original data.

9. The method of claim 8, wherein the one or more electronic files can be PDF files, spreadsheet files, document files, or text files.

10. The method of claim 8, further comprising:
providing, within the user interface presentation for selecting the one or more electronic files, an element for receiving an auxiliary user input for parsing the original data,
wherein providing the parsing input further comprises providing the auxiliary user input received through the user interface presentation as part of the parsing input.

11. The method of claim 1, wherein the machine learning model is a large language model configured to autoregressively apply self-attention at each of a plurality of generation steps.

12. The method of claim 1, further comprising, prior to providing the parsing input to the machine learning model:
providing a clarification input to the machine learning model that, when processed by the machine learning model, causes the machine learning model to determine whether there are one or more ambiguities in a data entry task; and
providing model-generated guidance describing how a user can refine user instructions for the data entry task based on the determined one or more ambiguities.

13. The method of claim 1, wherein the dynamic chunking input further causes the machine learning model to generate one or more focus ranges that promote a specific section of the source data as a primary data source for a corresponding chunk of the plurality of chunks.

14. The method of claim 1, wherein the parsing input causes the machine learning model to generate one or more intermediate scratch columns to facilitate multi-step reasoning lookups for generating the structured data output.

15. The method of claim 1, wherein providing the parsing input to the machine learning model comprises:
receiving, from the machine learning model, a flag indicating whether an end of a respective chunk has been reached; and
in response to determining that the flag indicates there are more rows to process for the respective chunk, repeatedly providing already generated rows back to the machine learning model to continue an extraction process until the flag indicates the end of the respective chunk has been reached.

16. The method of claim 5, further comprising:
determining that the structured data outputs generated by the machine learning model and the second machine learning model do not satisfy the one or more comparison criteria;
presenting a visual representation that highlights cell-level differences between the structured data outputs generated by the machine learning model and the second machine learning model; and
receiving a user input through the visual representation to correct the cell-level differences or to provide updated instructions to resolve the cell-level differences.

17. A system comprising:
one or more computers and one or more storage devices storing instructions that are operable, when executed by the one or more computers, to cause the one or more computers to perform operations comprising:
receiving, by a bioinformatics platform system comprising a plurality of computers, source data representing a plurality of attributes of one or more lab entities;
providing a dynamic chunking input to a machine learning model that, when processed by the machine learning model, causes the machine learning model to automatically analyze the source data and to partition the source data into a plurality of chunks to be processed separately;
providing a parsing input to the machine learning model that, when processed by the machine learning model, causes the machine learning model to separately analyze each separate chunk automatically generated by the model and to automatically generate, for each chunk, a structured data output corresponding to the plurality of attributes of the one or more lab entities in the source data; and
assembling the automatically generated structured data outputs generated for the plurality of chunks into a final structured data output.

18. The system of claim 17, wherein the operations further comprise:
presenting a visual representation of the final structured data output assembled from the automatically generated structured data outputs.

19. The system of claim 17, wherein the operations further comprise:
generating an electronic laboratory notebook entry based on the automatically generated structured data output; and
storing the electronic laboratory notebook entry in an electronic notebook entry database.

20. One or more non-transitory computer storage media encoded with computer program instructions that when executed by one or more computers cause the one or more computers to perform operations comprising:
receiving, by a bioinformatics platform system comprising a plurality of computers, source data representing a plurality of attributes of one or more lab entities;
providing a dynamic chunking input to a machine learning model that, when processed by the machine learning model, causes the machine learning model to automatically analyze the source data and to partition the source data into a plurality of chunks to be processed separately;
providing a parsing input to the machine learning model that, when processed by the machine learning model, causes the machine learning model to separately analyze each separate chunk automatically generated by the model and to automatically generate, for each chunk, a structured data output corresponding to the plurality of attributes of the one or more lab entities in the source data; and
assembling the automatically generated structured data outputs generated for the plurality of chunks into a final structured data output.
